(19) United States
(12) Patent Application Publication
(10) Pub. No.: US 2010/0088760 A1
(43) Pub. Date: Apr. 8, 2010

(54) DEBUG SECURITY LOGIC

(75) Inventors: Karl F. GREB, Missouri City, TX (US); Balatripura S. CHAVALI, Sugar Land, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/347,815

(22) Filed: Dec. 31, 2008

Related U.S. Application Data
(60) Provisional application No. 61/103,088, filed on Oct. 6, 2008.

(51) Int. Cl. G06F 21/22

(52) U.S. Cl. 726/21

(57) ABSTRACT

A system comprises debug logic usable to debug the system. The system also comprises processing logic capable of accessing the debug module using electronic signals. The system further comprises security logic configured to prevent the processing logic from accessing the debug logic unless the security logic is provided with a passkey that matches another passkey stored in the system.

### CROSS-REFERENCE TO RELATED APPLICATIONS

This application claims the benefit of U.S. Provisional Application Ser. No. 61/103,088, filed Oct. 6, 2008, titled “Automotive Debug Security Module,” and incorporated herein by reference as if reproduced in full below.

### BACKGROUND

Manufacturers of electronic devices generally debug the electronic devices prior to shipping the devices to distributors or retailers. Electronic devices are debugged using debug modules that are built into the devices. These debug modules are used during manufacture to ensure that the devices function properly. Thereafter, the debug modules are deactivated and physically left in place, even when the devices are shipped for distribution.

Because the debug modules remain in the electronic devices post-manufacture, malicious entities (e.g., hackers) have access to the debug modules and can use the debug modules to compromise the functional integrity of the electronic devices and/or the functional integrity of other devices communicably coupled with the electronic devices.

### SUMMARY

The problems noted above are solved in large part by a method and system for providing debug security logic. Some embodiments include a system comprises debug logic usable to debug the system. The system also comprises processing logic capable of accessing the debug module using electronic signals. The system further comprises security logic configured to prevent the processing logic from accessing the debug logic unless the security logic is provided with a passkey that matches another passkey stored in the system.

Another illustrative embodiment includes a system that comprises debug logic including an enablement port usable to enable and disable the debug logic. The system also comprises security logic that determines whether a request to access the debug logic is permissible. If the request is permissible, then, as a result, the security logic provides the enablement port with an enabling signal. If the request is impermissible, then, as a result, the security logic provides the enablement port with a disabling signal.

Yet another illustrative embodiment includes a method that comprises a security module detecting a request to access a debug module. The method also comprises the security module determining whether the request is permissible or impermissible. If the request is impermissible, then, as a result, the method includes the security module either preventing the request from being provided to the debug module or causing the debug module to become or remain disabled.

### BRIEF DESCRIPTION OF THE DRAWINGS

For a detailed description of exemplary embodiments of the invention, reference will now be made to the accompanying drawings in which:

FIG. 1 shows a block diagram of an illustrative system implementing the security techniques disclosed herein, in accordance with embodiments;

FIG. 2 shows a block diagram of an illustrative security logic in accordance with various embodiments;

FIG. 3 shows a detailed view of part of the security logic of FIG. 2, in accordance with embodiments;

FIG. 4 shows a block diagram of security logic, trace module debug logic, processing logic and debug control logic, in accordance with various embodiments;

FIG. 5 shows a flow diagram of an illustrative method implemented in accordance with embodiments; and

FIG. 6 shows a block diagram of an illustrative automotive apparatus that includes the security system described above in FIGS. 1-5, in accordance with embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. The terms “processor” and “processing logic” are analogous.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a security system that provides selective access to debug modules in post-manufacture electronic devices. The system protects against malicious access to multiple types of debug logic (e.g., memory mapped debug logic, autonomous/trace debug logic). Upon powering the electronic device in which the security system is embedded, the security system blocks access to the debug logic. To access the debug logic, a user must provide a key sequence to the security system. The key sequence must match a pre-programmed key sequence stored inside the security system. If the key sequences match, the user is permitted to access the debug logic. Otherwise, the debug logic remains inaccessible to the user. The debug logic remains inaccessible because the security system either blocks access to the debug logic or disables the debug logic altogether.

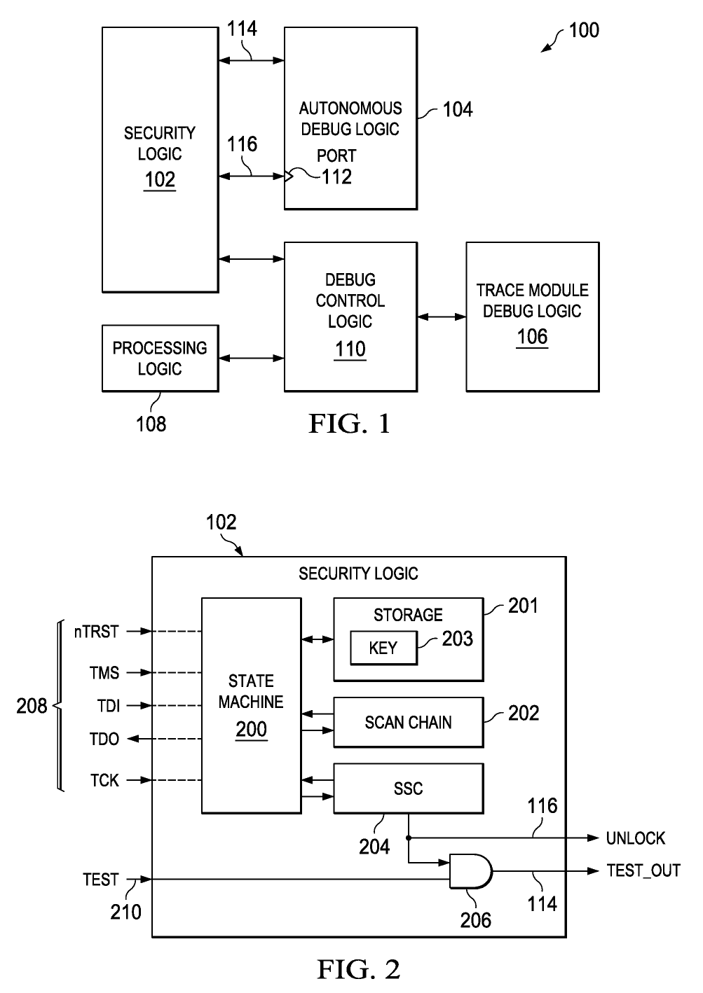

FIG. 1 shows a block diagram of an illustrative system 100 implementing the security techniques disclosed herein, in accordance with embodiments. The system 100 comprises security logic 102, autonomous debug logic 104, trace module debug logic 106, processing logic (e.g., a central processing unit) 108 and a debug control logic 110. Not all systems implementing the security techniques disclosed herein will contain all components shown in FIG. 1. For example, in some embodiments, debug logic 104 may be present while debug logic 106 is not, and in other embodiments, debug logic 106 ma be present while debug logic 104 is not.

The trace module debug logic 106 is generally used for the non-intrusive capture of product state. Trace output can be used to reconstruct the behavior of a system after such behavior has occurred, without impacting the behavior of the system. Trace module debug logic 106 generally receives debugging request signals from other components within the system 100, such as processing logic 108. In accordance with embodiments, debug control logic 110 is disposed in between the debug logic 106 and the processing logic 108. Signals transferred between the debug logic 106 and the processing logic 108 pass through the control logic 110. The security logic 102 controls the control logic 110. Accordingly, the security logic 102 can block signals that are intended to pass through the control logic 110 (e.g., signals intended to pass between the debug logic 106 and the processing logic 108).

Autonomous debug logic 104 is typically embedded within processing logic. The debug logic 104 generally is an intrusive mechanism which can probe and change logic state during system operation. The debug logic 104 receives debug data (as indicated by arrow 114) via the security logic 102. The debug data is provided to the security logic 102 by an external entity desiring to access the debug logic 104. The debug logic 104 uses the debug data to perform its debugging operations. However, the debug logic 104 will not perform debugging operations if the debug logic 104 is not enabled. Whether the debug logic 104 is enabled or not is dictated by enabling port 112. Specifically, the security logic 102 generates and provides to the port 112 an enabling signal when the security logic 102 determines that a request to access the debug logic 104 is permissible (i.e., “safe”). This enabling signal, provided to the port 112, causes the debug logic 104 to become or remain enabled. In contrast, when the security logic 102 determines that a particular request to access the debug logic 104 is impermissible (i.e., not “safe”), the security logic 102 generates and provides to the port 112 a disabling signal. The disabling signal causes the debug logic 104 to become or remain disabled. If the debug logic 104 is disabled, it does not become enabled until it receives an enabling signal. Similarly, if the debug logic 104 is enabled, it does not become disabled until it receives a disabling signal.

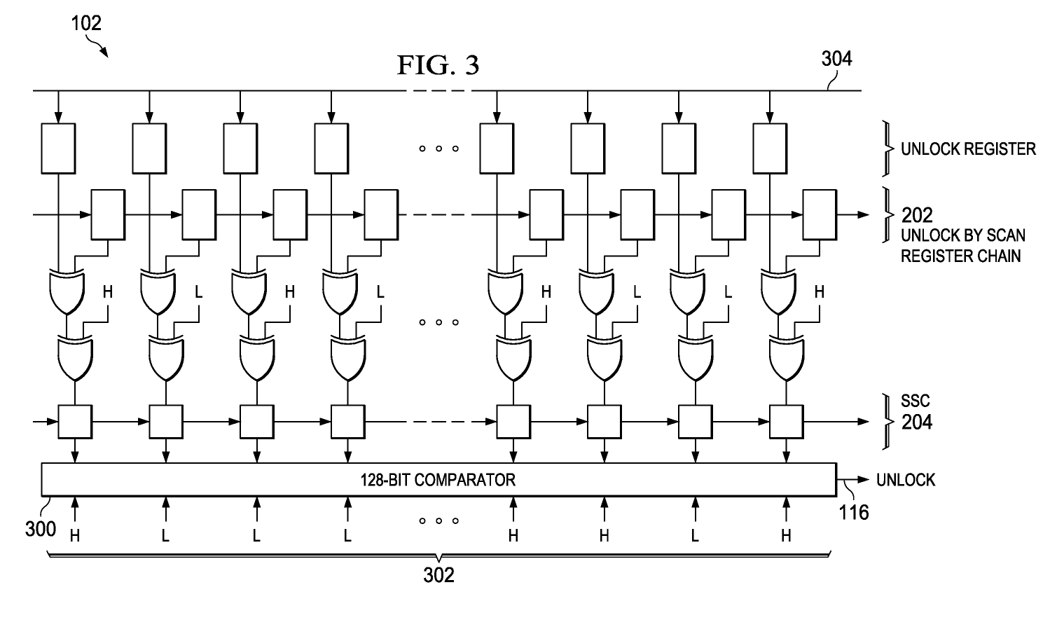

FIG. 2 shows a block diagram of illustrative security logic 102 in accordance with various embodiments. The security logic 102 comprises logic whose functionality is defined by a state machine 200 that sends and/or receives various signals 208. It should be understood than when the state machine 200 is described herein as “performing” some action, it is the actual circuit logic and/or security logic functionality which the state machine represents that actually undertakes this action. The state machine 200 uses the signals 208 to determine whether a particular request to access associated debug logic (e.g., debug logic 104 and/or 106) is permissible or impermissible. In making this determination, the state machine 200 uses scan chain 202, which is further described with reference to FIG. 3. The state machine 200 and scan chain 202 determine whether a particular request to access debug logic is permissible or impermissible by comparing a key received via signals 208 to a key stored on the security logic 102. For example, a received key may be compared to a key 203 stored in storage 201. If the keys match, access to the debug logic is granted. Otherwise, if the keys do not match, access is denied.

The security logic 102 also comprises a secondary scan chain (SSC) 204. The SSC 204, which is further described with reference to FIG. 3, is used to override the key-matching security feature (e.g., in case the key has been misplaced). Regardless of whether key comparison techniques are used to the override feature is used, if the security logic 102 determines that a particular debug logic access request should be granted, the security logic 102 asserts an UNLOCK signal 116, previously described with reference to FIG. 1. The UNLOCK signal 116 is provided to the enabling port 112 of debug logic 104, as shown in FIG. 1. The security logic 102 also comprises an AND gate 206. The AND gate 206 receives the UNLOCK signal 116 as one input and receives test/debug data 210 as a second input (e.g., from an entity wishing to access the debug logic and run the debug logic using the test/debug data). The output of the AND gate 206 is the TEST_OUT signal 114.

One purpose of the AND gate 206 is to hold test/debug data in the security logic 102 until the security logic 102 has determined that a debug logic access request associated with the test/debug data is permissible. If and when the request is deemed to be permissible, the UNLOCK signal 116 is asserted, thereby enabling whatever data is on the TEST signal 210 to pass through the AND gate 206 to TEST_OUT 114 and, subsequently, to the debug logic 104.

FIG. 3 shows a detailed view of part of the security logic 102. Data bus 304 carries a key provided (e.g., by a user) in association with a debug logic access request. The key is processed by a scan register chain 202. As previously mentioned, a SSC 204 is included in the security logic 102. The SSC 204 overrides the key comparison feature in case, e.g., the key has been misplaced or forgotten and an entity with proper security clearance (e.g., manufacturer, authorized repair personnel) needs to access the debug logic. The end result of the processing performed by scan chain 202 and the SSC 204 is provided to the comparator (e.g., 128-bit comparator or any of a variety of other, suitable key compare/algorithm mechanisms) 300. The comparator 300 compares the received, processed key with the key stored in memory (represented by numeral 302) and produces the UNLOCK signal 116. If the keys match, the comparator asserts the UNLOCK signal 212. If the keys do not match, the comparator de-asserts the UNLOCK signal 116.

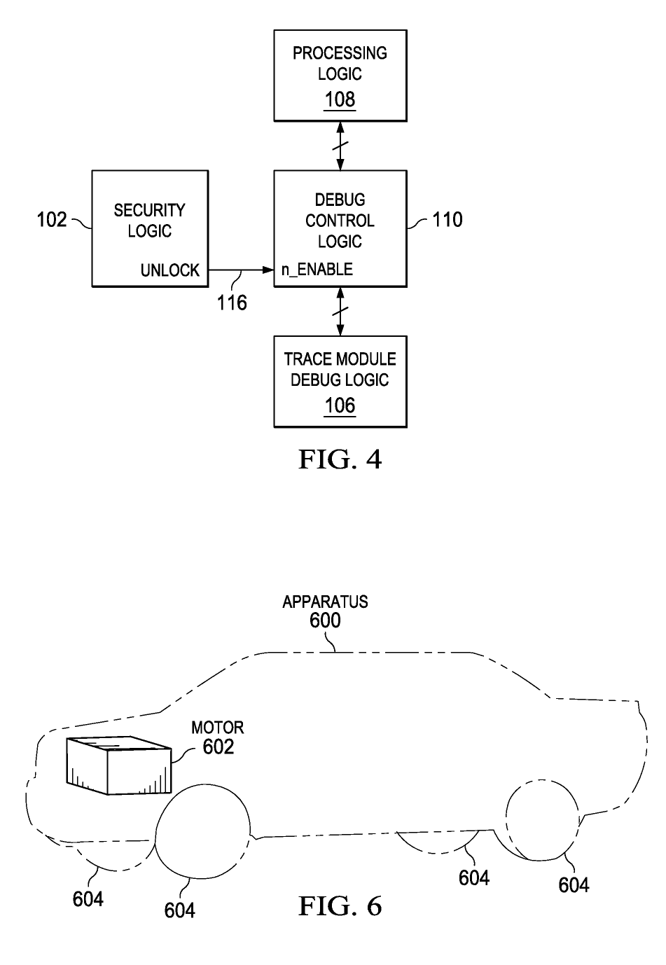

FIG. 4 shows a block diagram of the security logic 102, trace module debug logic 106, processing logic 108 and debug control logic 110, in accordance with various embodiments. The security logic 102 produces the UNLOCK signal 116, as previously explained. The UNLOCK signal 116 is provided to the autonomous debug logic 104, as shown in FIG. 1 and as previously described. However, the UNLOCK signal 116 also is provided to the debug control logic 110. The debug control logic 110, which couples the processing logic 108 and the trace module debug logic 106 and enables signals to pass therebetween, receives the UNLOCK signal 116 and either blocks or permits data traffic to flow depending on the status of the UNLOCK signal 116.

If the UNLOCK signal 116 is asserted, meaning that the debug access request is permissible, then, as a result, the debug control logic 110 permits data to flow between the processing logic 108 and the debug logic 106. However, if the UNLOCK signal 116 is unasserted, meaning that the debug access request is impermissible, then, as a result, the debug control logic 110 blocks data flow between the processing logic 108 and the debug logic 106. In at least some embodiments, the security logic 102 causes the debug control logic 110 to block this data flow by returning a bus error signal to the processing logic 108.

More specifically, when the processing logic 108 “desires” to access the debug logic 106, the processing logic 108 waits to receive a status signal from the debug logic 106 that indicates that the debug logic 106 is ready to receive debug data. However, when the UNLOCK signal 116 is unasserted, meaning that the debug logic access is not permitted, the debug control logic 110 takes control of the status signal and causes the status signal to indicate to the processing logic 108 that the debug logic 106 is not ready. Thus, regardless of whether or not the debug logic 106 is ready to receive debug data, if the debug logic access request is not permitted, the debug control logic 110 will continue to provide a status signal to the processing logic 108 that indicates that the debug logic 106 is not ready. As a result, the processing logic 108 will not access the debug logic 106.

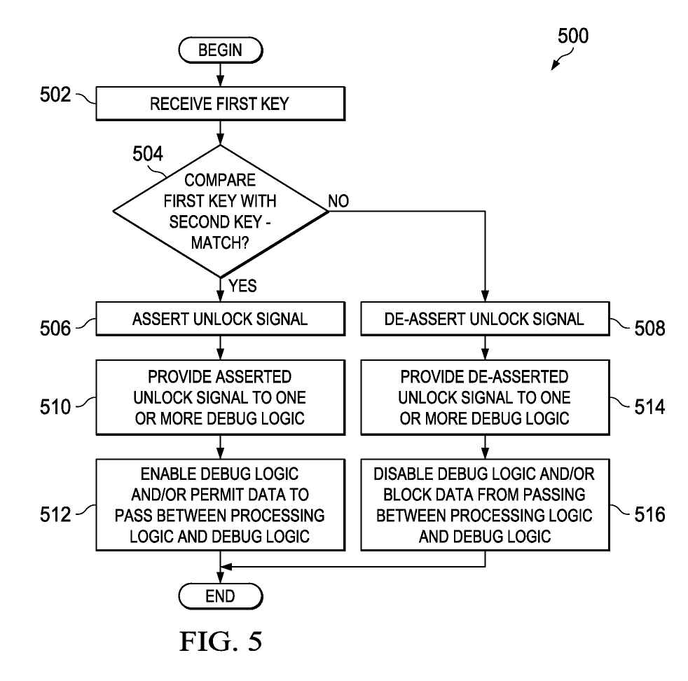

FIG. 5 shows a flow diagram of an illustrative method 500 implemented in accordance with embodiments. The method 500 begins with security logic receiving a key associated with a debug logic access request (block 502). The method 500 continues with the security logic comparing the key with another key stored on the security logic (block 504). The method 500 further comprises the security logic asserting the UNLOCK signal as a result of the keys matching (block 506) or de-asserting the UNLOCK signal as a result of the keys not matching (block 508). If the keys matched (block 506), the method 500 further comprises providing the asserted UNLOCK signal to one or more debug logic (block 510). The method 500 then comprises either enabling the debug logic and/or permitting data to pass between processing logic and the debug logic, depending on the type(s) of debug logic included in the system (block 512).

However, if the keys do not match and the UNLOCK signal is de-asserted (block 508), the method 500 comprises providing the unasserted UNLOCK signal to one or more debug logic (block 514). The method 500 then comprises either disabling the debug logic and/or blocking data from passing between processing logic and the debug logic, depending on the type(s) of debug logic included in the system (block 516).

FIG. 6 shows a block diagram of an illustrative apparatus 600 that includes the system 100 described above in FIGS. 1-5. In at least some embodiments, the apparatus 600 includes a motorized transportation apparatus (e.g., an automobile, a motor vehicle) that includes a motor 602 and wheels 604. Such an apparatus may comprise a car, truck, sport utility vehicle, airplane, golf cart, motorcycle, moped, SEGWAY®, etc.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
debug logic usable to debug the system;
processing logic capable of accessing the debug module using electronic signals; and
security logic configured to prevent the processing logic from accessing the debug logic unless the security logic is provided with a passkey that matches another passkey stored in said system.

2. The system of claim 1, wherein the system comprises an automobile.

3. The system of claim 1, wherein the debug logic comprises memory-mapped debug components.

4. The system of claim 1, wherein the security logic prevents the processing logic from accessing the debug logic by causing a ready signal to indicate that the debug logic is not ready for a debug request.

5. The system of claim 1, wherein the security logic prevents the processing logic from accessing the debug logic by causing a bus error signal to be sent to the processing logic.

6. The system of claim 1, wherein the security logic generates an unlocking signal usable to enable and disable autonomous trace debug logic.

7. The system of claim 1, further comprising a blocking device disposed between the debug logic and the processing logic, wherein the blocking device receives a signal from the security logic that causes the blocking device to either enable or disable communications between the debug logic and the processing logic.

8. A system, comprising:
debug logic comprising an enablement port usable to enable and disable the debug logic; and
security logic that determines whether a request to access the debug logic is permissible;
wherein, if the request is permissible, then, as a result, the security logic provides the enablement port with an enabling signal;
wherein, if the request is impermissible, then, as a result, the security logic provides the enablement port with a disabling signal.

9. The system of claim 8, wherein the system comprises a motor vehicle.

10. The system of claim 8, wherein the security logic comprises an AND gate, said AND gate having a test signal as a first input and the AND gate having one of the enabling signal and the disabling signal as a second input.

11. The system of claim 8, wherein the security logic determines whether said request is permissible or impermissible by comparing a first key stored in the security logic with a second key provided in association with said request.

12. The system of claim 11, wherein the security logic is configured to override the key comparison such that said request is determined to be permissible.

13. The system of claim 11, wherein the security logic receives test data with said request, and wherein the security logic provides the test data to the debug logic as a result of said keys matching.

14. The system of claim 8, wherein the debug logic comprises autonomous debug logic.

15. A method, comprising:
a security module detecting a request to access a debug module;
the security module determining whether said request is permissible or impermissible; and
if said request is impermissible, then, as a result, the security module either preventing the request from being provided to the debug module or causing the debug module to become or remain disabled.

16. The method of claim 15, wherein preventing the request from being provided to the debug module comprises causing a blocking device to block processing logic access to the debug logic.

17. The method of claim 16, wherein causing a blocking device to block said access comprises the blocking device providing a bus error signal to the processing logic.

18. The method of claim 15, wherein causing the debug module to become or remain disabled comprises the security module providing a disabling signal to the debug logic, the disabling signal generated as a result of comparing a key stored on the security module to another key provided to the security module in concert with said request.

19. The method of claim 15, further comprising incorporating said security module into a motorized transportation apparatus.
